(19) United States
(12) Patent Application Publication
(10) Pub. No.: US 2015/0356671 A1
(43) Pub. Date: Dec. 10, 2015

(54) SYSTEM, METHOD, AND APPARATUS FOR AUTOMATED COST OF SALE BIDDING

(71) Applicants: Howard Shi Kin Wan, Lexington, MA (US); Sudhir Mohan, Saratoga, CA (US); Sizhe Tan, Berkeley, CA (US); Ryan Sue, Fremont, CA (US); Sanjib Gupta, Milpitas, CA (US); Krishna K. Tiwari, San Francisco, CA (US); Khatereh Khodavirdi, Los Angeles, CA (US); Anahita Tafvizi, Foster City, CA (US); Rishi Das, Fremont, CA (US)

(72) Inventors: Howard Shi Kin Wan, Lexington, MA (US); Sudhir Mohan, Saratoga, CA (US); Sizhe Tan, Berkeley, CA (US); Ryan Sue, Fremont, CA (US); Sanjib Gupta, Milpitas, CA (US); Krishna K. Tiwari, San Francisco, CA (US); Khatereh Khodavirdi, Los Angeles, CA (US); Anahita Tafvizi, Foster City, CA (US); Rishi Das, Fremont, CA (US)

(21) Appl. No.: 14/483,090

(22) Filed: Sep. 10, 2014

Related U.S. Application Data
(60) Provisional application No. 62/009,131, filed on Jun. 6, 2014.

(51) Int. Cl. G06Q 30/08

(52) U.S. Cl. CPC G06Q 30/08

(57) ABSTRACT

The present disclosure is directed to apparatuses, systems, and methods for automatically managing cost of sale (COS) bidding for merchants (alternatively referred to herein as “vendors”). Described herein are automated COS bidding processes (or automated COS bidding logic, modules, or engines) utilized such that merchants need not actively manage their bids (i.e., fees associated with displaying item listings). As described herein, embodiments automate merchant bids using a formula based, at least in part, on the price of the item, the cost of selling from the advertiser, and historical performance data.

### CLAIM OF PRIORITY

This application claims the benefit of priority to U.S. Provisional Patent Application Ser. No. 62/009,131, filed on Jun. 6, 2014, which is incorporated by reference herein in its entirety.

### TECHNICAL FIELD

The present application relates generally to the technical field of data processing and, in particular, to providing a process for automatically managing cost of sale bidding for merchants.

### BACKGROUND

Presently, publication systems, such as e-commerce systems, may provide a Comparison Shopping Engine (CSE) for displaying item listings from multiple merchants across multiple categories. The merchants place bids—i.e., a fee for displaying the item listing—on item listings as commissions to the CSE. Current solutions require merchants to manually manage their bid values, which is a time-intensive process for merchants with multiple item listings across multiple categories, and may lead to non-optimal bid values. A non-optimal bid value may lead to low sales volume for an item, or a disproportionately high cost for displaying the item listing on the CSE relative to the sale price of the item.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 illustrates a network architecture of an exemplary system according to aspects of the disclosure.

FIG. 2 illustrates exemplary applications executable by one or more application servers according to aspects of the disclosure.

FIG. 3 illustrates an exemplary client machine according to aspects of the disclosure.

FIG. 4 is a block diagram illustrating components of a machine, according to some example embodiments, able to read instructions from a machine-readable medium and perform any one or more of the methodologies discussed herein, according to aspects of the disclosure.

FIG. 5 illustrates a web page of a publication system configured to publish item listings pursuant to merchant bids according to aspects of the disclosure.

FIG. 6 is a flow diagram of a process for creating and updating a bid for an item listing to be published via a comparison shopping engine, according to an embodiment.

FIG. 7 is a flow diagram of a process for calculating an initial bid for an item listing to be published via a comparison shopping engine, according to an embodiment.

FIG. 8 is a flow diagram of a process for adjusting a bid for an item listing published via a comparison shopping engine, according to an embodiment.

FIG. 9 is a block diagram of a system and an associated process flow for managing item listing bids for a comparison shopping engine, according to an embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques have not been shown in detail.

The present disclosure is directed to apparatuses, systems, and methods for automatically managing cost of sale (COS) bidding for merchants (alternatively referred to herein as “vendors”). Described herein are automated COS bidding processes (or automated COS bidding logic, modules, or engines) utilized such that merchants need not actively manage their bids (i.e., fees associated with displaying item listings). As described in further detail below, embodiments automate merchant bids using a formula based, at least in part, on the price of the item, the cost of selling from the advertiser, and historical performance data.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to execute the instructions.

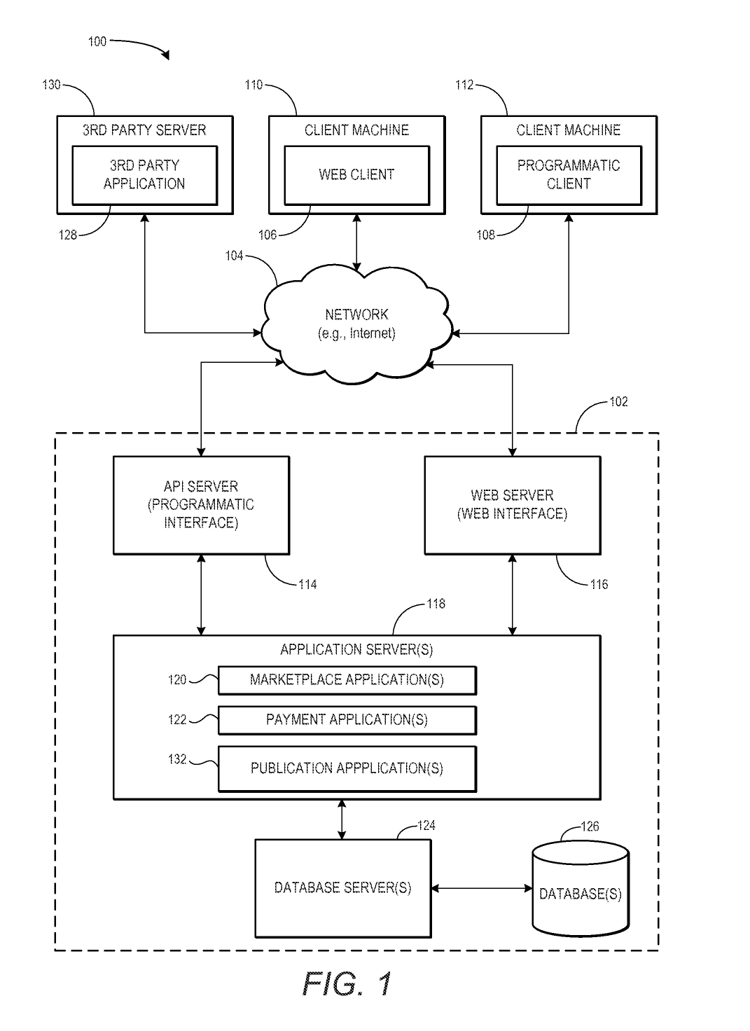

FIG. 1 is a network diagram depicting a client-server system 100 according to aspects of the disclosure. A networked system 102, in the example forms of a network-based marketplace or publication system (e.g., a Comparison Shopping Engine (CSE)), provides server-side functionality, via a network 104 (e.g., the Internet or a Wide Area Network (WAN)), to one or more client machines. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An Application Programming Interface (API) server 114 and a web server 116 are coupled to, and provide programmatic and web interfaces respectively to, one or more application servers 118. The application server(s) 118 host one or more applications, such as a marketplace application(s) 120, a payment application(s) 122, and one or more publication applications 132. The application server(s) 118 are, in turn, shown to be coupled to one or more database servers 124 that facilitate access to one or more databases 126.

The marketplace application(s) 120 may provide a number of marketplace functions and services to users who access the networked system 102. The payment application(s) 122 may likewise provide a number of payment services and functions to users. The payment application(s) 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace application(s) 120.

As discussed further below, price ranges and price points may be collected from one or more sources, such as items being offered for sale through an electronic marketplace, items being offered at auctions hosted by the electronic marketplace, items having been previously sold through the electronic marketplace, external sources (e.g., APIs to other electronic marketplaces), and other such sources. Thus, when a search query is received for items being offered for sale through the electronic marketplace, the application server(s) 118 may provide one or more price ranges for the prices of search results that correspond to the received search query.

In one embodiment, the databases 126 are storage devices that store information to be posted (e.g., publications or listings) via the publication application(s) 132. The databases 126 may also store digital goods information in accordance with example embodiments.

In example embodiments, the publication application(s) 132 publishes content on a network (e.g., the Internet). As such, the publication application(s) 132 provides a number of publication and marketplace functions and services to users who access the networked system 102. In example embodiments, the publication application(s) 132 is discussed in terms of an online marketplace environment. However, it is noted that the publication application(s) 132 may be associated with a non-marketplace environment such as an informational (e.g., search engine) or social-networking environment.

While the marketplace application(s) 120, the payment application(s) 122, and the publication application(s) 132 are shown in FIG. 1 to form part of the networked system 102, it will be appreciated that, in alternative embodiments, the applications 120, 122, and 132 may be separate and distinct from the networked system 102. For example, the payment application(s) 122 may form part of a payment service that is separate and distinct from the networked system 102.

Further, while the system 100 shown in FIG. 1 employs a client-server architecture, the embodiments are of course not limited to such an architecture, and could equally well find application in a distributed, or peer-to-peer, architecture system, for example. The marketplace application(s) 120, the payment application(s) 122, and the publication application(s) 132 could also be implemented as standalone software programs, which do not necessarily have networking capabilities.

The web client 106 may access the marketplace application(s) 120, the payment application(s) 122, and the publication application(s) 132 via the web interface supported by the web server 116. Similarly, the programmatic client 108 may access the various services and functions provided by the applications 120, 122, and 132 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, payment, or advertising functions that are supported by the relevant applications of the networked system 102.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services.

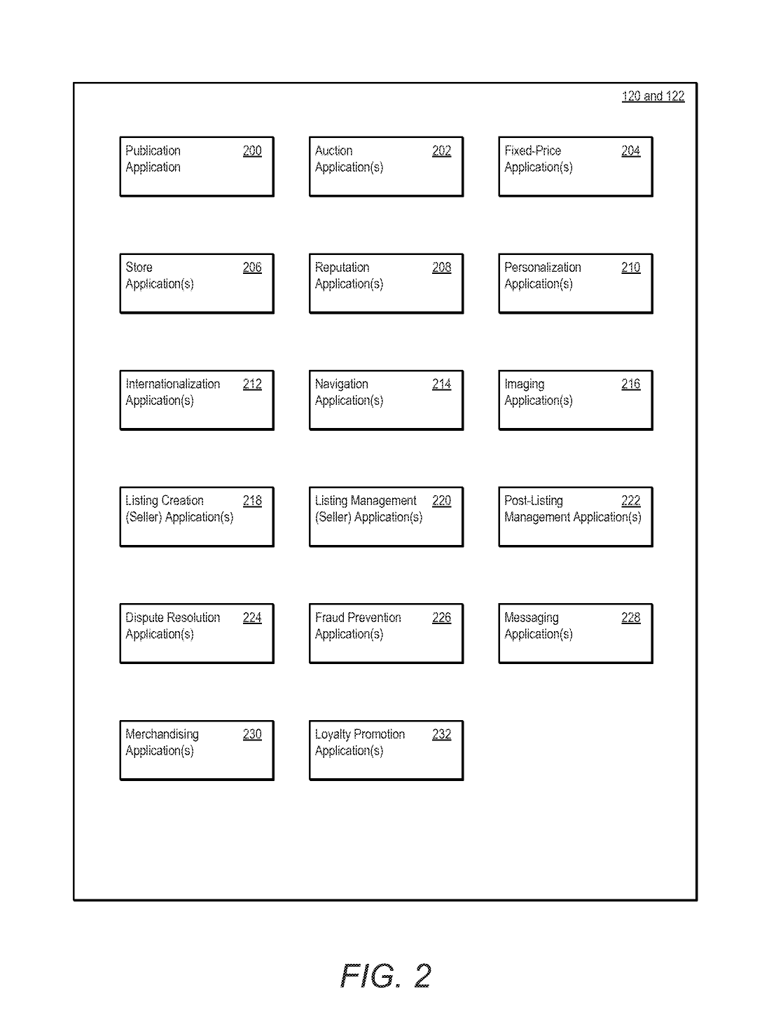

FIG. 2 illustrates exemplary applications that may be executable by the foregoing application server(s) 118 to support the aforementioned mechanisms. To this end, the marketplace application 120 and the payment application 122 are shown to include at least one publication application 200 (including at least publication application(s) 132) and one or more auction applications 202, which support auction-format listing and price setting mechanisms (e.g., English, Dutch, Vickrey, Chinese, Double, and Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing one of the appropriate personalization applications 210, create a personalized reference page on which information regarding transactions to which the user is (or has been) a party may be viewed. Further, one of the personalization applications 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information in (and/or the presentation of information by) the networked system 102 according to predetermined criteria (e.g., geographic, demographic, or marketplace criteria). For example, the internationalization applications 212 may be used to support the customization of information for a number of regional websites that are operated by the networked system 102 and that are accessible via the web server 116.

Navigation of the networked system 102 may be facilitated by one or more navigation applications 214. For example, a search application (as an example of one of the navigation applications 214) may enable key word searches of listings published via the networked system 102. A browsing application may allow users to browse various category, catalogue, or inventory data structures according to which listings may be classified within the networked system 102. Various others of the navigation applications 214 may be provided to supplement the search and browsing applications.

In order to make the listings available via the networked system 102 as visually informative and attractive as possible, the applications 120 and 122 may include one or more imaging applications 216, which users may utilize to upload images for inclusion within listings. The imaging applications 216 also operate to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, one or more post-listing management applications 222 may provide an interface to one or more reputation applications 208, so as to allow the seller conveniently to provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or providing promotional and merchandising information to users). Respective messaging applications 228 may utilize any one of a number of message delivery networks and platforms to deliver messages to users. For example, the messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and may be offered a reward for which accumulated loyalty points can be redeemed.

Furthermore, and referring back to FIG. 1, the publication application(s) 132 may leverage one or more of the applications 200-232 for automatically managing cost of sale bidding for merchants. In other words, the publication application(s) 132 may invoke or use data gathered by the applications 200-232 for cost of sale bidding management processes. For example, the publication application(s) 132 may obtain one or more search queries via the navigation application(s) 214, and prices for the various listings via the auction application(s) 202 and/or the fixed-price application(s) 204. The publication application(s) 132 may also access other applications shown in FIG. 2, such as the store application(s) 206, to obtain prices for items that were previously sold.

As the publication application(s) 132 may be integrated (e.g., directly or indirectly) with the application server(s) 118, the publication application(s) 132 may leverage the data obtained from the applications 200-232 and provide relatively up-to-date or current listings for items being offered through the electronic marketplace. This integration may further extend to the one or more database server(s) 124 and/or database(s) 126 in communication with the application server(s) 118.

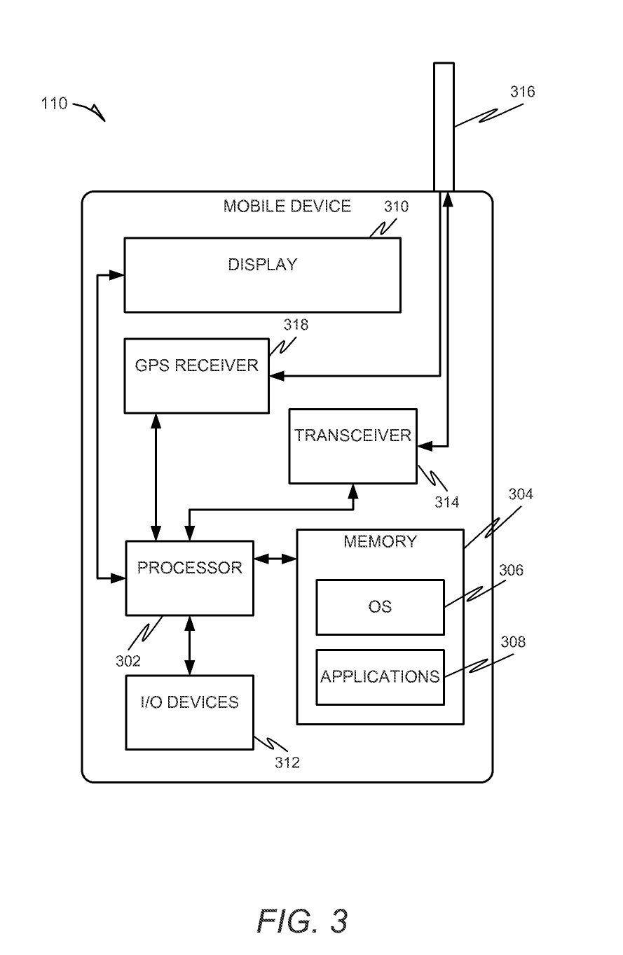

FIG. 3 illustrates one example for one of the client machines 110 in accordance with aspects of the disclosure. In one embodiment, the client machine 110 may be a mobile device. The mobile device may include a processor 302. The processor 302 may be any of a variety of different types of commercially available processors suitable for mobile devices (e.g., an ARM architecture microprocessor, a Microprocessor without Interlocked Pipeline Stages (MIPS) architecture processor, or another type of processor). A memory 304, such as a random access memory (RAM), a Flash memory, or another type of memory, is typically accessible to the processor 302. The memory 304 may be adapted to store an operating system (OS) 306, as well as applications 308, such as a mobile location enabled application that can provide location-based services to a user. The processor 302 may be coupled, either directly or via appropriate intermediary hardware, to a display 310 and to one or more input/output (I/O) devices 312, such as a keypad, a touch panel sensor, a microphone, and the like. In some embodiments, the display 310 comprises a touchscreen display capable of functioning as an I/O device. Similarly, in some embodiments, the processor 302 can be coupled to a transceiver 314 that interfaces with an antenna 316. The transceiver 314 may be configured to both transmit and receive cellular network signals, wireless data signals, or other types of signals via the antenna 316, depending on the nature of the mobile device 110. Further, in some configurations, a GPS receiver 318 may also make use of the antenna 316 to receive GPS signals.

The applications 308 of the client mobile device 110 may further include one or more browser applications, such as mobile browser applications, which may be used to provide a user interface to permit the user to browse information available over a network interface. The applications 308 may further include one or more provider-specific mobile applications (alternatively referred to herein as “mobile apps”), downloaded (e.g., downloaded by the user from a mobile software distribution platform) and resident on the client mobile device 110, that enable the user to access content through the mobile app in addition to said mobile browser application.

As referred to herein, mobile browsers and mobile apps may describe computer programs designed to run specifically on mobile devices such as smartphones, tablet computers, other handheld computing devices, etc. Mobile browsers and mobile apps may be designed with consideration of the constraints (e.g., low-power processors, limited memory, etc.) and features (e.g., location identification capabilities using geo-location sensors, integrated cellular telephone connectivity, etc.) of mobile devices. Mobile browsers and mobile apps may also implement mobile user interface (UI) designs that consider constraints of the screen size of the display 310, touchscreen capabilities of the display 310, etc.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., an FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments. It is contemplated that any features of any embodiments disclosed herein can be combined with any other features of any other embodiments disclosed herein. Accordingly, any such hybrid embodiments are within the scope of the present disclosure.

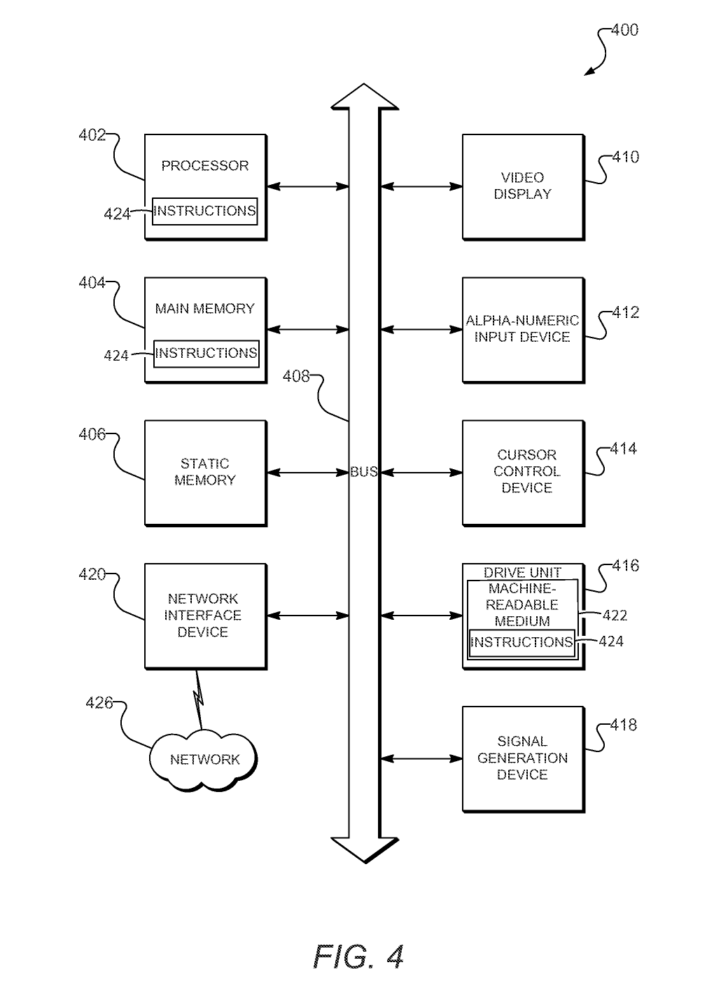

FIG. 4 is a block diagram illustrating components of a machine, according to some example embodiments, able to read instructions from a machine-readable medium and perform any one or more of the methodologies discussed herein, according to aspects of the disclosure. In particular, FIG. 4 illustrates an exemplary computer system 400 within which instructions 424 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU), or both), a main memory 404, and a static memory 406, which communicate with each other via a bus 408. The computer system 400 may further include a video display 410 (e.g., a liquid crystal display (LCD) or a cathode ray tube (CRT)). The computer system 400 also includes an alphanumeric input device 412 (e.g., a keyboard), a UI navigation (or cursor control) device 414 (e.g., a mouse), a disk drive unit 416, a signal generation device 418 (e.g., a speaker) and a network interface device 420.

The disk drive unit 416 includes a non-transitory machine-readable medium 422 on which is stored one or more sets of data structures and instructions 424 (e.g., software) embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting non-transitory, machine-readable media. The instructions 424 may alternatively reside, completely or at least partially, within the static memory 406.

While the non-transitory machine-readable medium 422 is shown in an example embodiment to be a single medium, the term “machine-readable medium” may include a single medium or multiple media (e.g., a centralized or distributed database, and/or associated caches and servers) that store the one or more data structures and instructions 424. The term “machine-readable medium” shall also be taken to include any tangible medium that is capable of storing, encoding, or carrying instructions for execution by the machine and that cause the machine to perform any one or more of the methodologies of the present embodiments, or that is capable of storing, encoding, or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disk-read-only memory (CD-ROM) and digital versatile disk (or digital video disk) read-only memory (DVD-ROM) disks.

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

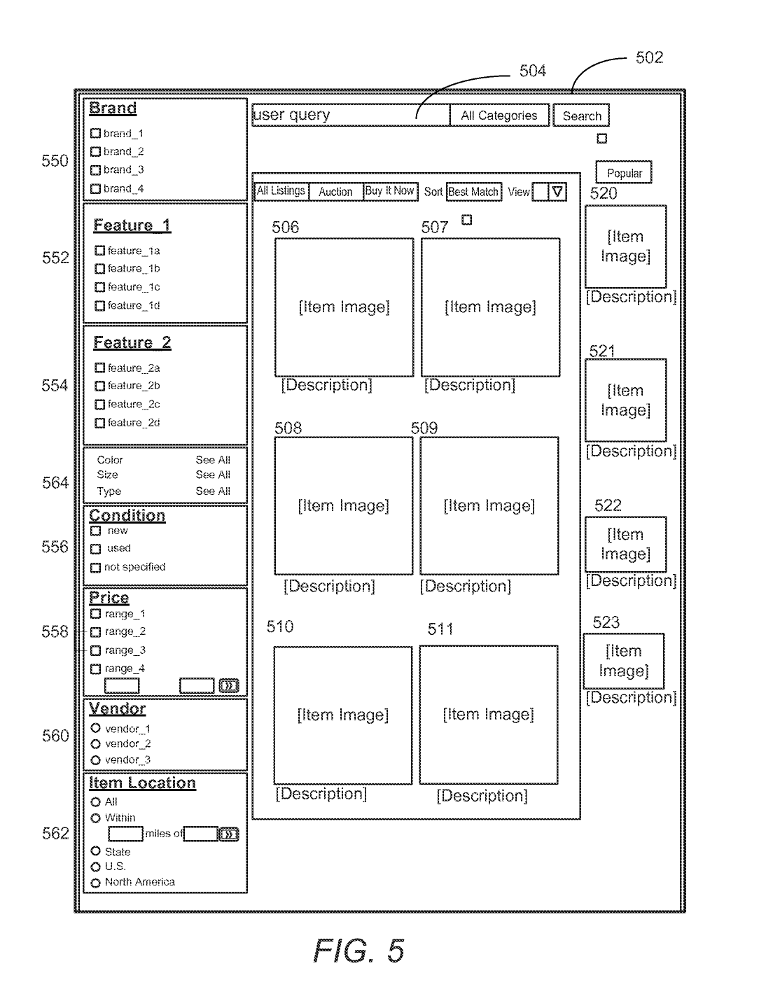

FIG. 5 illustrates a webpage 502 of a publication system (e.g., a CSE) configured to publish item listings pursuant to merchant bids according to aspects of the disclosure. The webpage 502 may include an element, such as a text entry box 504, where the user may provide a search query to search for listings offered by the CSE. The webpage 502 and subsequent exemplary web pages illustrated and described below may alternatively comprise mobile browser or mobile app implementations in other embodiments.

The displayed search results may include listings 506-511 that are selected (from a larger set of listings, some of which may be displayed on subsequent pages) to be displayed based, at least in part, on the listings' relevance to the search query entered into the text entry box 504, and on bids associated with each listing (described in further detail below). Each of the listings 506-511 is shown to include an item image and an item description, each of the item descriptions may include a title, price, brand identification, etc.

In this embodiment, listings 520-523 comprise a second set of listings that are selected for display according to a different metric than that used to select the listings 506-511. In this embodiment, the listings 520-523 are displayed based, at least in part, on popularity (i.e., different user views) in addition to relevance to the search query entered into the text entry box 504 and bids associated with each listing.

In this embodiment, a plurality of filters 550-564 and corresponding filter values are displayed; these filters are selectable for narrowing the scope of displayed search results for the search query entered into the text entry box 504. The filters 550-564 are shown in this example to include a brand filter 550, item feature filters 552 and 554 (labeled generically in this figure as “Feature_{—}1” and “Feature_{—}2”), an item condition filter 556, a price filter 558, a vendor filter 560, and an item location filter 562. The price filter 558 and the item location filter 562 are shown to accept manual user input to configure the filter. In addition, an expandable filter set 564 is displayed to allow the user to further narrow the scope of displayed search results for the search query.

For the example publication system, the publisher offers listings that appear on the webpage 502 as an ad space for vendors to purchase. The publisher may determine where on webpage 502 certain item listings (which may alternatively be referred to as “deals,” “advertisements,” etc.) are displayed in response to a user search query. For example, the publisher may conduct a keyword auction in which vendors may bid a certain amount to associate their advertisements with one or more keywords. This bid may further dictate the placement of different vendors' deals on the webpage 502; in other words, a deal associated with a higher bid may command a more prominent position on the webpage 502 (i.e., the position of the deal 506 may be associated with a higher bid compared to that of the position of the deal 511, the position of a deal appearing on a subsequent results page, etc.). In other embodiments, deals associated with higher bids may be displayed differently to increase the impression of the deal on the webpage 502 (e.g., bolded text, highlighted background fill for the published deal, etc.).

Where and how often a deal is published on the webpage 502 in response to a search query may determine how many users perform an action on the deal (e.g., a “click” on a hyperlink associated with one of the deals 506-511 to view the deal). The ratio of the number of clicks a deal receives out of the number of times it is displayed may be referred to herein as a click-through rate (CTR). Higher click-through rates result in more users visiting the vendor listing, thereby providing an increased business opportunity (e.g., in addition to item sale opportunities, clicking on a deal may redirect the user to the vendor's web site, thereby increasing web traffic for the vendor's web site).

Publishers typically charge a fee per user action on a published deal; thus, prominent placement of a deal on the webpage 502 is associated with a greater cost for the vendor to pay. An example of a cost per user action scheme is cost per click (CPC); other examples include cost per impression (CPM), cost per action (CPA), etc. Because a vendor's bid is multiplied by their respective cost per user action, a high bid increases CPC, which increases the COS for the deal; conversely, a low bid lowers the CPC, which decreases the COS for the deal

Prominent placement of a deal in response to a search query is not always preferred, as a vendor may receive a high amount of unqualified deal clicks, which decreases the conversion to sales (CTS) ratio. For example, in response to a user search query “digital camera,” a deal to prominently display a high-end professional-grade digital camera may lead to a low CTS ratio, as users entering this query may typically be searching for consumer-level (i.e., cheaper) products. A vendor tries to anticipate the CTS ratio when deciding how much to bid on a deal. Typically, the vendor then monitors the CTS ratio to re-adjust the bid regularly. It may be a challenge for vendors to monitor the CTS ratio for thousands of different bids on a daily basis.

In order to protect their COS, vendors tend to bid low for their deals when the CTS ratio is unknown. This results in less potential profit for the vendor, as this low bid may result in the deal not having enough traffic (i.e., a low CTR) to acquire reasonable sales. Alternatively, vendors may choose to limit the number of published deals if they lack the resources to manage their bids. This results in poor selection for the CSE, poor deal CTR, and lower profit for both the vendor and the CSE publisher.

Embodiments of the disclosure utilize automated COS bidding processes (or execute automated COS bidding logic, modules, or engines) such that merchants need not actively manage their bids. As described in further detail below, embodiments automate the vendor bids using a formula based, at least in part, on the price of the item, the cost of selling from the advertiser, and historical performance data.

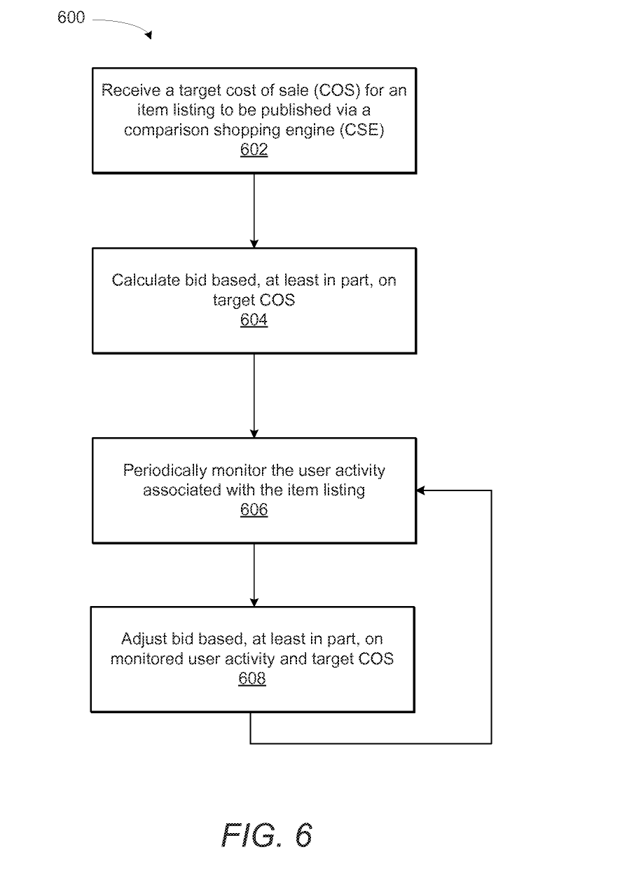

FIG. 6 is a flow diagram of a process for creating and updating a bid for an item listing to be published via a CSE, according to an embodiment. Logical flow diagrams as illustrated herein provide examples of sequences of various process actions. Although shown in a particular sequence or order, unless otherwise specified, the order of the actions can be modified. Thus, the described and illustrated implementations should be understood only as examples, and the illustrated processes can be performed in a different order, and some actions may be performed in parallel. Additionally, one or more actions can be omitted in various embodiments; thus, not all actions are required in every implementation. Other process flows are possible.

Logic flow 600 includes receiving a target COS from a merchant for an item listing to be published via a CSE (block 602). In some embodiments, an item listing may be published under a plurality of categories, and a different target COS may be associated with a different category. For example, the CSE may have a “digital cameras” category, which includes item listings for a wide variety of digital cameras. A target COS for a high-end professional-grade digital camera may be low in this category to prevent unqualified clicks, as users entering this query may typically be searching for consumer-level (i.e., cheaper) products. However, if the CSE has a more specific, high-end category (e.g., “professional grade digital cameras”), the target COS for said high-end professional-grade digital camera may be relatively higher to increase the CTR of the item listing when it is published for this category.

An initial bid is calculated based, at least in part, on the received target COS (block 604). As discussed above, this initial bid is associated with publication of the item listing, via the CSE, in response to received user queries. The item listing is at least periodically monitored (e.g., daily, weekly, or continuously in real time) to determine if the user actions and actual purchases of the item correspond to the initial bid and the received target COS (i.e., the CTS ratio) (block 606). The initial bid may be adjusted based, at least in part, on the target COS and the actual CTS ratio (block 608).

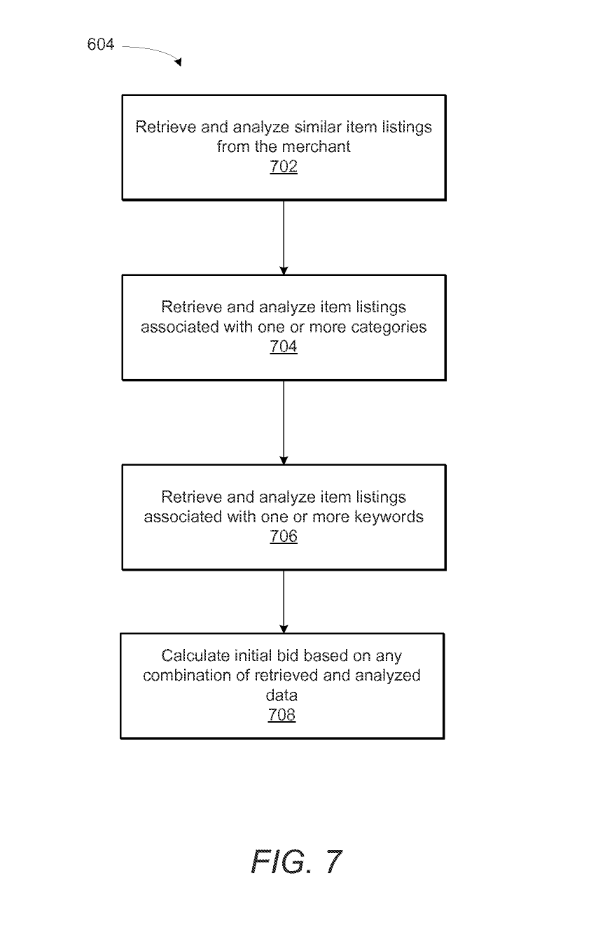

FIG. 7 is a flow diagram of a process for calculating an initial bid for an item listing to be published via a CSE, according to an embodiment. The flow diagram illustrated and described below is an example embodiment for the operation of block 604 of FIG. 6; other embodiments may utilize other processes.

The CSE stores historical data associated with various item listings such that a prediction model may be executed to determine an initial bid for an item listing. Similar item listings and associated data from the merchant are retrieved and analyzed (block 702). This may include previously automated and/or non-automated bids for items. The associated data may include price, user activity tracking, sales data, etc. Item listings and associated data related to one or more related categories are retrieved and analyzed (block 704). These categories may include categories specified by the merchant's bid, in addition to other categories not specified by the merchant's bid (e.g., similar brands, similar merchant types, etc.). Item listings and associated data related to one or more expected user queries (e.g., keywords) are retrieved and analyzed (block 706). As discussed above, the initial bid may be for a keyword auction in which the merchant may bid a certain amount to associate its advertisement with one or more keywords; thus item listings related to these keywords, and similar keywords, may be retrieved. The initial bid may be calculated based on any combination of the above described retrieved and analyzed data (block 708).

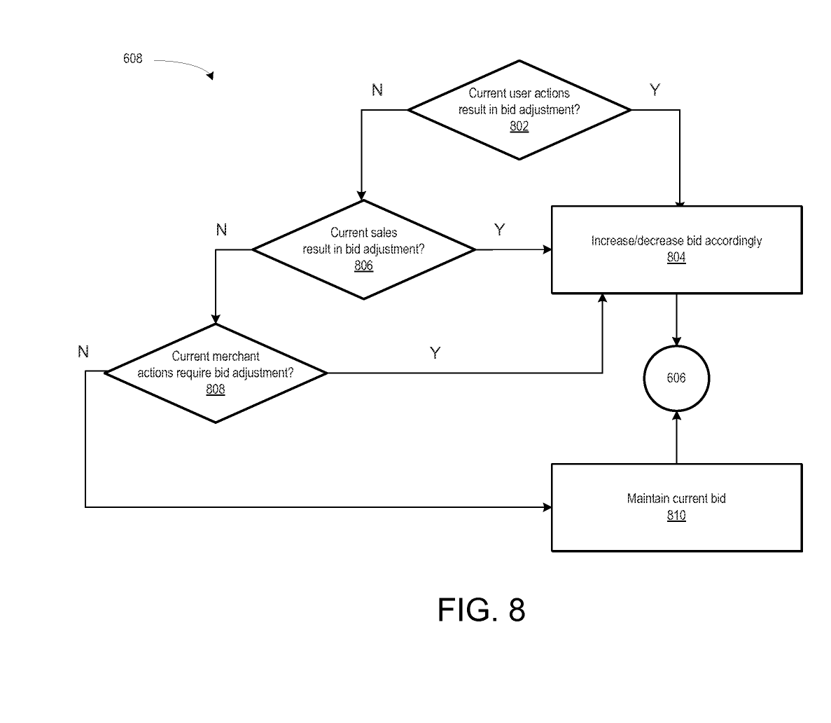

FIG. 8 is a flow diagram of a process for adjusting a bid for an item listing published via a CSE, according to an embodiment. The flow diagram illustrated and described below is an example embodiment for the operation of block 608 of FIG. 6; other embodiments may utilize other processes.

User actions for the item listing are periodically monitored to determine if the initial (or current) bid is to be adjusted (block 802). For example, an initial bid may be too low, so that not enough clicks (i.e., user viewings of the item listing) are occurring, or an initial bid may be too high, so that a large number of unqualified clicks are adversely affecting the CTS ratio. Thus, the bid may be increased or decreased accordingly (block 804).

Sales data is periodically reviewed to determine if the initial (or current) bid is to be adjusted (block 806). For example, current sales volume related to an item listing may be too low, so that an increase in the bid for the item listing may create an increase in sales, thereby adjusting the CTS ratio of the item listing. The average CTS ratio for an item listing may also be higher than expected, and thus the bid may be increased to ensure the deal is being thoroughly advertised. Thus, the bid may be increased or decreased accordingly (block 804).

Merchants may periodically update aspects of the item listing (block 808). For example, if the merchant increases or decrease the target COS, the bid may be increased or decreased automatically. If the merchant increases or decreases the price of the item associated with the item listing, the bid may be increased or decreased automatically. If no adjustments are made, the initial (or current) bid may be maintained until the user action, sales data, and merchant data is reviewed again (block 810).

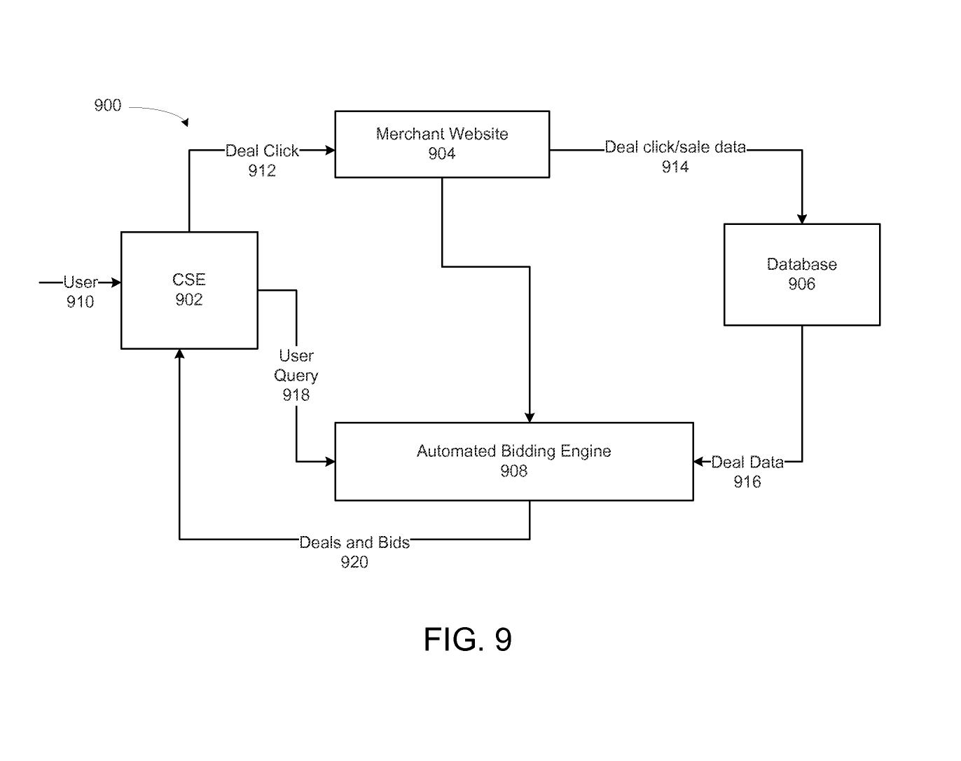

FIG. 9 is a block diagram of a system and an associated process flow for managing item listing bids for a CSE, according to an embodiment. A system 900 is shown to include a CSE 902 that publishes various deals from various merchants. In this embodiment, a user 910 enters a user query 918 to view a plurality of deals. Relevant deals and bids 920 (described in further detail below) are received and published by the CSE 902. When the user 910 selects a deal through a deal click 912, the user 910 is redirected to a merchant website 904 in this embodiment. Data 914 indicating whether the user 910 purchased the clicked deal is transmitted to a database 906. The database 906 is used in this embodiment to store various merchants' specific information—i.e., merchandise-specific information, the merchant category, performance metrics such as the average price of the items that the merchant sells over a given period, etc. Any combination of this data is shown as deal data 916. The database 906 is accessed to transmit the deal data 916 to an automated COS bidding engine 908, which also receives the user query 918. The automated COS bidding engine 908 sends the generated deals and bids 920 to the CSE 902 for publication.

The automated COS bidding engine 908 may execute any process to determine an initial or modified bid for any given deal. For example, the automated COS bidding engine 908 may determine a bid (referred to below as COSBID) based on a received COS from a merchant using the formula:

COSBID=Approximate_Bid*COS_Regulator

wherein the approximate bid may be determined using the formula:

Approximate_Bid=Price_average×CTS_average×(Price/(Price_average))DF×COS_target

In the above formula, “Price_average” is the average deal price for a given period for similar item listings, “CTS_average” is the average CTS per merchant per top form, over a given time period, “Price” is the price listed in the deal, and “COS_target” is the target COS set by the merchant.

In some embodiments, a dampening factor DF may be used to control the magnitude of the bid adjustment. The dampening factor is used to control the approximation of the COS bid relative to the given average price CTS and target COS. The dampening factor value may be different for different categories or for different merchants. The value may be applied to all merchants and for all categories in some embodiments. It is a value that may be derived from research and simulations based on historical data sets.

A regulating multiplier (COS_Regulator) may be determined using the formula:

COS_Regulator=(COS_target/(COS_current))0.5

Wherein COS_current is the observed COS per merchant per top form over a given time period, using routinely collected data. Thus, the example embodiment calculates and routinely adjusts an approximate bid dynamically per query, merchant, category, and result set. This process helps ensure that the target COS for a deal is met while maximizing the impression of the deal to increase both CTR and the CTS ratio.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A non-transitory machine-useable storage medium embodying instructions which, when executed by a machine, cause the machine to execute operations to:
receive a target cost-of-sale (COS) for an item listing to be published through an electronic marketplace;
calculate a bid associated with publication of the item listing via through the electronic marketplace in response to received user queries, wherein the calculated bid comprises a cost per user action on the item listing and is based, at least in part, on data related to similar item listings;
calculate a projected COS for the item listing based, at least in part, on real-time sales data for the item listing and a real-time quantity of user actions on the item listing; and
dynamically adjust the bid associated with publication of the item listing through the electronic marketplace based, at least in part, on a difference between the projected COS for the item listing and the target COS for the item listing.

2. The non-transitory machine-useable storage medium of claim 1, wherein the cost per user action comprises at least one of a cost per click (CPC), a cost per impression (CPM), or a cost per action (CPA).

3. The non-transitory machine-useable storage medium of claim 1, wherein the operation to dynamically adjust the bid associated with publication of the item listing is executed in response to receiving at least one of an updated target COS for the item listing, or an updated item price for the item listing.

4. The non-transitory machine-useable storage medium of claim 1, wherein the data related to similar item listings comprises at least one of an item price of each of the similar item listings, a user action quantity for each of the similar item listings, or a COS for each of the similar item listings.

5. The non-transitory machine-useable storage medium of claim 1, wherein the received target COS for the item listing is associated with a first category of a plurality of categories, and wherein the item listing is associated with different COS values for different categories of the plurality of categories.

6. The non-transitory machine-useable storage medium of claim 1, wherein the operation to dynamically adjust the bid associated with publication of the item listing comprises an operation to increase the bid in response to the projected COS for the item listing being lower than the received target COS.

7. The non-transitory machine-useable storage medium of claim 1, wherein the operation to dynamically adjust the bid associated with publication of the item listing comprises an operation to decrease the bid in response to the projected COS for the item listing being higher than the received target COS.

8. The non-transitory machine-useable storage medium of claim 1, wherein the operation to dynamically adjust the bid associated with publication of the item listing includes an operation to utilize a dampening value to control the adjustment of the bid.

9. A computer-implemented method comprising:
receiving a target cost-of-sale (COS) for an item listing to be published through an electronic marketplace;
calculating a bid associated with publication of the item listing through the electronic marketplace in response to received user queries, wherein the calculated bid comprises a cost per user action on the item listing and is based, at least in part, on data related to similar item listings;
calculating a projected COS for the item listing based, at least in part, on real-time sales data for the item listing and a real-time quantity of user actions on the item listing; and
dynamically adjusting the bid associated with publication of the item listing through the electronic marketplace based, at least in part, on a difference between the projected COS for the item listing and the target COS for the item listing.

10. The method of claim 9, wherein the cost per user action comprises at least one of a cost per click (CPC), a cost per impression (CPM), or a cost per action (CPA).

11. The method of claim 9, wherein dynamically adjusting the bid associated with publication of the item listing is in response to receiving at least one of an updated target COS for the item listing, or an updated item price for the item listing.

12. The method of claim 9, wherein the data related to similar item listings comprises at least one of an item price of each of the similar item listings, a user action quantity for each of the similar item listings, or a COS for each of the similar item listings.

13. A system comprising:
an automated cost of sale (COS) bidding engine to:
receive a target COS for an item listing to be published through an electronic marketplace;
calculate a bid associated with publication of the item listing through the electronic marketplace in response to received user queries, wherein the calculated bid comprises a cost per user action on the item listing and is based, at least in part, on data related to similar item listings;
calculate a projected COS for the item listing based, at least in part, on real-time sales data for the item listing and a real-time quantity of user actions on the item listing; and
dynamically adjust the bid associated with publication of the item listing through the electronic marketplace based, at least in part, on a difference between the projected COS for the item listing and the target COS for the item listing;
one or more memory devices communicatively coupled to the automated COS bidding engine; and
one or more processors to execute the automated COS bidding engine.

14. The system of claim 13, wherein the cost per user action comprises at least one of a cost per click (CPC), a cost per impression (CPM), or a cost per action (CPA).

15. The system of claim 13, wherein the operation of the automated COS bidding engine to dynamically adjust the bid associated with publication of the item listing is executed in response to receiving at least one of an updated target COS for the item listing, or an updated item price for the item listing.

16. The system of claim 13, wherein the data related to similar item listings comprises at least one of an item price of each of the similar item listings, a user action quantity for each of the similar item listings, or a COS for each of the similar item listings.

17. The system of claim 13, wherein the received target COS for the item listing is associated with a first category of a plurality of categories, and wherein the item listing is associated with different COS values for different categories of the plurality of categories.

18. The system of claim 13, wherein the automated COS bidding engine, when dynamically adjusting the bid associated with publication of the item listing, is to increase the bid in response to the projected COS for the item listing being lower than the received target COS.

19. The system of claim 13, wherein the automated COS bidding engine, when dynamically adjusting the bid associated with publication of the item listing, is to decrease the bid in response to the projected COS for the item listing being higher than the received target COS.

20. The system of claim 13, wherein the automated COS bidding engine, when dynamically adjusting the bid associated with publication of the item listing, is to utilize a dampening value to control the adjustment of the bid.
